(19) United States
(12) Patent Application Publication
(10) Pub. No.: US 2002/0116497 A1
(43) Pub. Date: Aug. 22, 2002

(54) Method for managing PC to PC audio communications

(76) Inventor: Berkat S. Tung, Sacramento, CA (US)

Correspondence Address: Carmen C. Cook, SKJERVEN MORRILL MacPHERSON LLP, 25 Metro Drive, Suite 700, San Jose, CA, 95110-1349, US

(21) Appl. No.: 09/733,331

(22) Filed: Dec. 7, 2000

(51) Int. Cl. G06F 15/16

(52) U.S. Cl. 709/227

(57) ABSTRACT

A method for providing audio communications between a first client and a second client includes accessing a web site, providing link information to an entry node, providing login information of the first client to the entry node and registering the first client with a first server. The first client queries a second server to obtain an on-line presence status of the second client. If the on-line presence status indicates that the second client is on-line, the first client queries the second server for link information of the second client, and establishes a connection between the first client and the second client for audio communication. The method of the present invention allows a user of an internet telephone service to quickly determine the on-line presence of other users of the service so that PC to PC telephone calls can be placed to those users who are on-line.

### REFERENCE TO APPENDICES

Appendix A, which is an integral part of the present disclosure, includes computer program listings of program modules for the database servers (referred to as SIM servers) for implementing the PC to PC audio communications method according to one embodiment of the present invention.

Appendix B, which is an integral part of the present disclosure, contains the program interface used in the communications system between the SIM servers, the web server script, the client applet and the client agent for managing PC to PC calls according to one embodiment of the present invention.

Appendices A and B contain copyrighted material. The copyright owner, Dialpad.com, Inc., has no objection to the facsimile reproduction by anyone of the patent documents or patent disclosure, as it appears in the Patent and Trademark Office patent files or records, but otherwise reserves all copyrights whatsoever.

### BACKGROUND OF THE INVENTION

1. Field of the Invention

The invention relates to a method in managing telephone calls between personal computers (PCs), and more particularly to a method for managing the on-line presence information of users to facilitate PC to PC communications.

2. Description of the Related Art

Internet telephone services are known and becoming widely available. Personal computers having suitable hardware and software may be used to place telephone calls via a data network such as the Internet using existing Internet communication protocols. This form of communication is commonly referred to as the Voice over internet protocol (VOIP) technology which is based on the ITU-T H.323 standard and supports audio, video, data, or fax communications using the internet protocol (IP) on the publicly accessible Internet and within private intranets.

Typical VoIP communications allow a caller to place a telephone call from his/her personal computer (PC) through a data network, such as the Internet, to another personal computer or an audio communication device, such as a wired or wireless telephone. For example, when the caller is calling a conventional telephone, the caller accesses an internet telephone service provider's web site which provides an interface to the internet telephone service. The caller then enters the telephone number he wishes to dial. The telephone service “dials” the telephone number and “rings” the destination telephone.

Internet telephone services also support two-way VOIP communications between two personal computers, commonly referred to as PC to PC calls. The internet telephone service provider needs to maintain information concerning the presence or absence of its users in order to facilitate PC to PC calls. When the number of users of the internet telephone service provider is large, the task of maintaining the user on-line information becomes cumbersome and if not properly managed, can impact the efficiency of the internet telephone service.

It is desirable to provide a method for maintaining user information including on-line presence status to facilitate PC to PC calling using an internet telephone service.

### SUMMARY OF THE INVENTION

According to the present invention, a method for providing audio communications between a first client and a second client includes accessing a web site, providing link information to an entry node, providing login information of the first client to the entry node and registering the first client with a first server. The method further includes querying a second server to obtain an on-line presence status of the second client. If the on-line presence status indicates that the second client is on-line, the first client queries the second server for link information of the second client, and establishes a connection between the first client and the second client for audio communication.

The method of the present invention allows a user of an internet telephone service to quickly determine the on-line presence of other users of the service so that PC to PC telephone calls can be placed to those users who are on-line. Furthermore, the method provides client-side load balancing to improve the performance of the internet telephone service. The method of the present invention incorporates scalability so that a communications system implementing the method can support any number of users.

The present invention is better understood upon consideration of the detailed description below and the accompanying drawings.

### BRIEF DESCRIPTION OF THE DRAWINGS

FIG. 1 is a flow chart illustrating a process 100 for providing PC to PC audio communications according to one embodiment of the present invention.

FIG. 2a is a flow chart illustrating the operation of logging in a user and registering the user with a designated SIM server according to one embodiment of the present invention.

FIG. 2b is a flow chart illustrating the process a client used to register with a SIM server according to one embodiment of the present invention.

FIG. 2c is a flow chart illustrating the operation of logging in a user and registering the user with a designated SIM server according to another embodiment of the present invention.

FIG. 3 is a flow chart illustrating the process for determining the on-line presence status of a user according to one embodiment of the present invention.

FIG. 4 depicts schematically a communications system in which a VOIP server is used to provide audio communications between a user A and a user B according to one embodiment of the present invention.

In the present disclosure, like objects which appear in more than one figure are provided with like reference numerals.

### DETAILED DESCRIPTION OF THE PREFERRED EMBODIMENTS

In accordance with the present invention, a method for facilitating audio communications between two personal computers using VoIP protocols is provided. In one embodiment, a user of an internet telephone service can quickly determine the on-line presence of other users of the internet telephone service so that PC to PC telephone calls can be placed to those users who are on-line. Furthermore, the method provides client-side load balancing to improve the performance of the internet telephone service. The method of the present invention also incorporates scalability so that the method can be used in an internet telephone service to support any number of users.

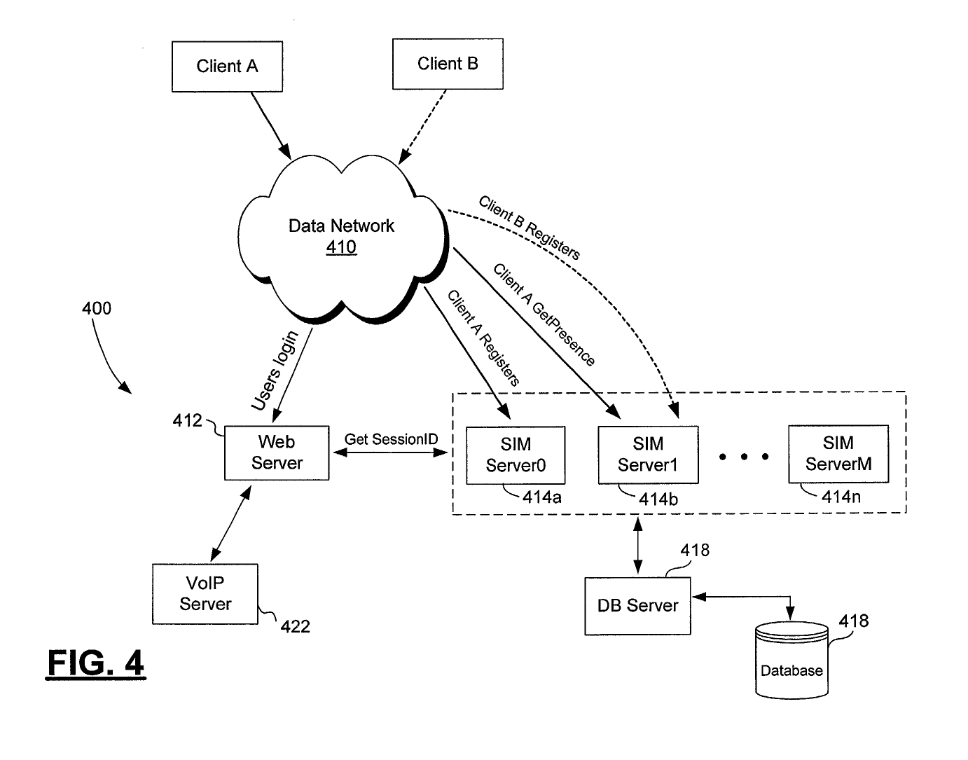

FIG. 4 depicts schematically a communications system 400 in which a VOIP server 422 is used to provide audio communication between a user A and a user B. In FIG. 4, client A and client B represent the respective client program being executed on the personal computers of user A and user B, respectively, for establishing VOIP communications. An exemplary client is a conventional personal computer with access to data network 410 and running a web browser such as Microsoft Internet Explorer™ or Netscape Navigator™. In the present description, client A and client B are representative of any number of clients which access communications system 400 for establishing VoIP communications. Client A and client B are connected to communications system 400 through a data network 410 which can be the publicly accessible Internet or a private data network. In the present embodiment, VOIP communication between client A and client B is established according to the method described in co-pending and commonly assigned U.S. patent application Ser. No. 09/401,898, entitled “Scaleable Communications System,” of Wongyu Cho et al., filed Sep. 24, 1999, which is incorporated herein by reference in its entirety. A client and remote client communicate directly through data network 410 using the messages specified in the '898 patent application. In the '898 patent application, a client initiates communication with a remote client using the TCP connect message in which the IP address and port of the remote client are specified. In the present embodiment, the internet telephone service is one provided by Dialpad.com of Santa Clara, Calif. In other embodiments, other methods for providing internet telephone services can be used, such as those provided by Phonefree.com, and Net2phone.

Communications system 400 of FIG. 4 includes web server 412 hosting a web site for providing a graphical interface for users associated with the internet telephone service provider operating system 400. Communications system 400 also includes a VoIP server 422 for facilitating VoIP communications. In one embodiment, VoIP server 422 supports the communication protocols based on the ITU-T H.323 standard. Communications system 400 further includes one or more database servers denoted session information manager (SIM) servers 414a-n in FIG. 4. In the present invention, SIM servers 414a-n are used to store connection information of users who are “on-line” and also information of the active sessions in communications system 400. In the present description, a user is deemed to be “on-line” if the user has logged onto web server 412 and registered with one of SIM servers 414a-n. Communications system 400 may further include other data base servers, such as DB server 418 in communication with a database 418. DB server 418 may be used to store user identification information such as the UserName, UserID, and associated password for each user with authorized access to communications system 400.

In the present embodiment, communications system 400 includes one or more SIM servers 414a-n for storing user connection and session information. Thus, SIM servers 414a-n are responsible for managing web sessions of the users, performing registration of the users, and managing the on-line presence status of the users. The method of providing PC to PC audio communications of the present invention performs client-side load balancing for distributing the load evenly among the SIM servers so as to optimize the performance of the communications system. By using client-side load balancing, each of the SIM servers can operate independently of each other and without intercommunications between the servers. Thus, communications system 400 is scalable and any number of SIM servers can be included to support any number of users of system 400. SIM servers 414a-n can be any conventional DB servers and in the present embodiment, SIM servers 414a-n are each a single-process, multi-thread server.

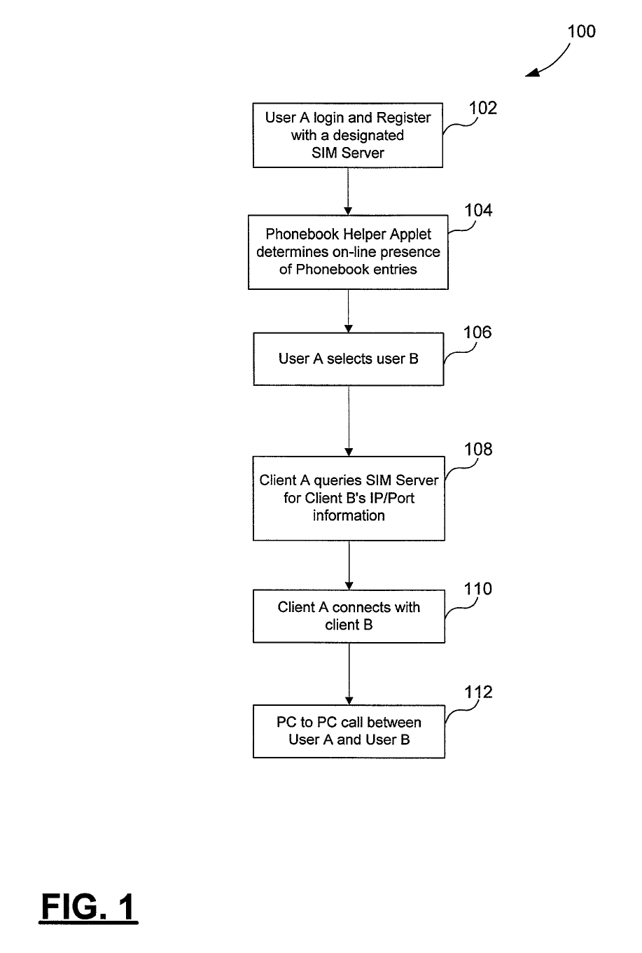

FIG. 1 is a flow chart illustrating a process 100 for providing PC to PC audio communications according to one embodiment of the present invention. A user A, wishing to communicate with another user (for example, user B) using VoIP communications, logins at communications system 400 and registers with a designated SIM server associated with system 400 (step 102). After login and registration, communications system 400 (through web server 412) provides client A a phonebook containing, among other things, identification information of other users of system 400 created by user A. A phonebook helper applet is executed to determine the on-line presence of the users identified in user A's phonebook (step 104). User A can select to place a PC to PC call to any one of the users identified in the phonebook as being currently on-line. In the present description, user A selects user B for placing a PC to PC call (step 106). Client A queries a designated SIM server for client B's connection information, including the IP address and port number of client B (step 108). Client A then connects to client B using the IP address and port number obtained from the designated SIM server (step 110). The connection can be established using TCP/IP, for example. The connection can also be established using the protocols described in the '898 patent application. User A and user B can then proceed with voice communications on their respective PCs using RTP protocols, for example (step 112). Appendix A contains code segments used to perform steps 102, 104 and 108 of process 100 in FIG. 1. The detailed operation of each step in process 100 is described below.

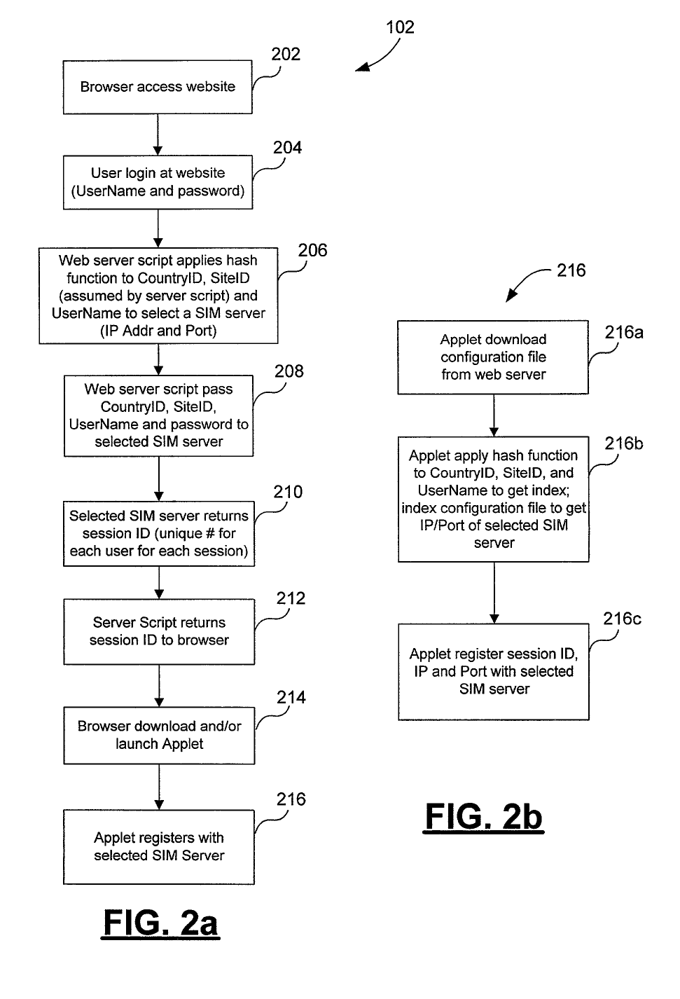

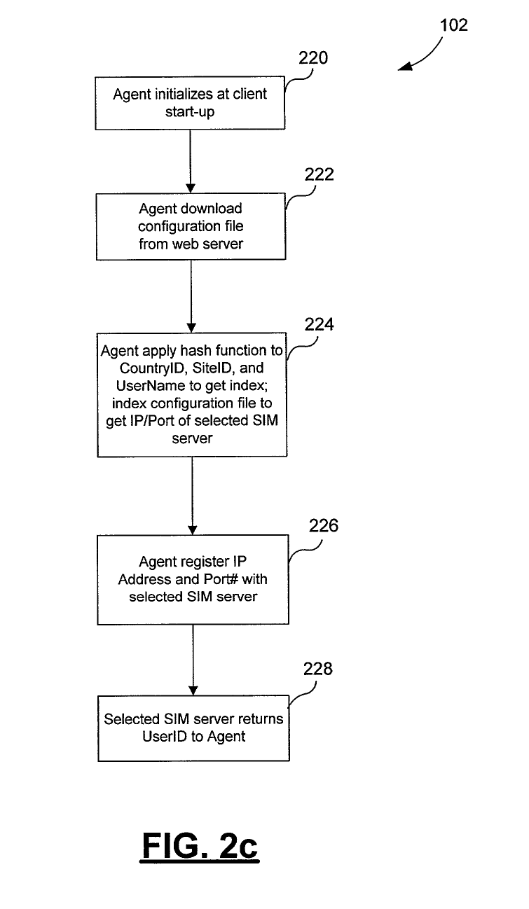

FIG. 2a is a flow chart illustrating the operation of step 102 of process 100 for logging in a user and registering the user with a designated SIM server according to one embodiment of the present invention. In step 202, user A with access to data network 410 uses a web browser being executed on a personal computer (client A) to access a web site hosted by web server 412. The web site may include graphical content prompting user A to login in with communications system 400. At step 204, user A logins using a UserName and password. At step 206, web server 412 of communications system 400 executes a common gateway interface (CGI) script (hereinafter “web server script”) which, among other things, performs a hash operation. The web server script applies a hash function to a set of user identification values associated with user A to determine which one of SIM servers 414a-n is to be used for registering client A and maintaining client A's connection and session information. In the present embodiment, the hash function is applied to the countryID, siteID and UserName of user A. The countryID and siteID of user A is provided by web server 412 which has information concerning the country and the server site user A has logged on. Below is a code segment HashID2Name written in C for implementing the hash function used in the present embodiment.

DWORD HashID2Name (DWORD dwCountryID, DWORD
dwSiteID, BYTE *pbUserName)
{

int len = strlen ( (char *)pbUserName);
int i;
DWORD dwH;
dwH = dwCountryID * g_dwPrime + dwSiteID;
for (i=len-1; i>=0; i--)
{

if (dwH > 500000)

dwH %= dwSIMCount;

dwH = dwH * g_dwPrime + (DWORD)
pbUserName[i];

}
return dwH % dwSIMCount;

}

The hash function above returns an index value identifying one of SIM servers 414a-n. For instance, the index value can be a number between 0 to N−1 for identifying N number of SIM servers. The web server script uses the index value to index a table containing an array of index values with the associated IP address and port numbers of the SIM servers. Using the index value generated by the hash function, the web server script can then select a SIM server which is assigned to manage client A's session and connection information. For the purpose of this description, the index value returned for user A is 0 and thus the selected SIM server is SIM Server0 414a. The web server script use the index value to obtain the IP address and port number of SIM Server0. At step 208, the web server script passes the user identification values including the countryID, siteID, UserName and password to selected SIM Server0 414a. In return, SIM ServerO 414a returns a session ID to the web server script (step 210). The session ID is assigned to the current session of client A and uniquely identifies client A in communications system 400. At step 212, the web server script running on web server 412 returns the session ID assigned by SIM Server0 414a to client A through data network 410. At step 214, client A download an applet which is the client side program for establishing VoIP communications with VoIP server 422 if client A does not have the applet already downloaded. Then client A launches the applet. When the applet is launched, the applet performs initialization routines which include registering client A with the selected SIM Server0 414a (step 216). After registration, user A can proceed with process 100 of FIG. 1 for placing a PC to PC call using VoIP server 422.

FIG. 2b is a flow chart illustrating the process Client A used to register with SIM Server0 414a. At step 216a, the applet downloads a configuration file from web server 412. The configuration file includes an index array of SIM server index values and the associated SIM server IP address and port number. The index array in the configuration file is the same index array used by web server 412 previously to select one of SIM servers 414a-n. The applet at client A then applies the same hash function as previously described to the user identification values (i.e. countryID, siteID, and UserName) to obtain an index value (step 216b). The index value is used to index the configuration file which returns the IP address and port number of SIM Server0 414a. The applet then establishes a connection with SIM Server0 using TCP/IP, for example, and registers with SIM Server0 (step 216c). The applet registers with SIM Server0 by providing the SIM server its session ID, IP address and port number. In this manner, SIM Server0 retains the on-line presence information of client A. Other users of communications system 400, wishing to call user A, may obtain the on-line presence information of client A from SIM Server0 as will be explained in more detail below.

According to another embodiment of the present invention, during the duration of time client A is on-line, the applet of client A sends a data packet to its designated SIM server (SIM Server0 414a) periodically to notify the SIM server that the client is still on-line so as to maintain the client's on-line presence status at the SIM server. For example, in one embodiment, the on-line presence status of a client is timed out and the client's registration is terminated when the designated SIM server 414a-n does not receive any communication from the client for more than one minute. Thus, after registration, client A, who is on-line and wishes to maintain its on-line presence status with SIM Server0, sends a “KeepAlive” data packet about every minute to SIM Server0 to maintain its on-line presence status.

The above description discusses the registration process of one user at a selected SIM server. Of course, in the normal course of operation of communications system 400, numerous clients login to system 400 and register with a selected one of SIM servers 414a-n according to the process described above. The hash function described above serves to distribute the users of system 400 more or less evenly among SIM servers 414a-n so that a single SIM server does not end up handling an excessive number of users. Furthermore, by performing hashing at the client side for the purpose of registration and for the purpose of determine on-line presence of users, the clients can be directed to the designated SIM servers directly, obviating the need for a centralized server to direct traffic which can create bottleneck problems. By providing client-side hashing, a given user of system 400 is able to determine which SIM server to go to for registration. Furthermore, other users of system 400 will always know which SIM server to go to for determining if the user is currently on-line. The use of client side hashing greatly improve system efficiency.

According to another embodiment of the present invention, communications system 400 provides a tray application (also referred to as an agent or an agent application) installed on the PC of a user for facilitating PC to PC telephone communications. A user may obtain the agent application from web server 412 of communications system 400. For example, web server 412 may provide a web page as a user interface to allow the user to download the agent application. The agent application, after being downloaded, is installed and executed automatically as is conventionally done. The agent application can perform several functions, including monitoring incoming calls for client A and performing login function for client A. In the present embodiment, after downloading and installing the agent application, the user may configure the agent application with the user's UserName and password. The registration process used to register a client using an agent is illustrated in FIG. 2c. Referring to FIG. 2c, when client A (such as the browser) starts up, the agent application is initialized (step 220). At step 222, the agent downloads a configuration file from web server 412. The configuration file includes an index array of SIM server index values and the associated SIM server IP address and port number. The index array in the configuration file is the same index array used by web server 412 previously to select one of SIM servers 414a-n. The agent application at client A then applies the same hash function as previously described to the user identification values (i.e. countryID, siteID, and UserName) to obtain an index value (step 224). The index value is used to index the configuration file which returns the IP address and port number of SIM Server0 414a. The agent then establishes a connection with SIM Server0 using TCP/IP, for example, and registers with SIM Server0 (step 226). The agent registers with SIM Server0 by providing the SIM server its IP address and port number. The SIM server returns the UserID of client A to the agent application (step 228). In this manner, the agent of client A registers with SIM Server0 and SIM Server0 retains the on-line presence information of client A. According to another embodiment of the present invention, after an agent registers with a SIM server, the agent of the client sends a “KeepAlive” data packet to the designated SIM server periodically to maintain the on-line presence status of the agent application. For example, when the SIM servers are programmed to time-out a client-agent's registration if no communication is received for more than 2 minutes, the agent application transmits a “KeepAlive” data packet about every 2 minutes to maintain the on-line presence status of the agent.

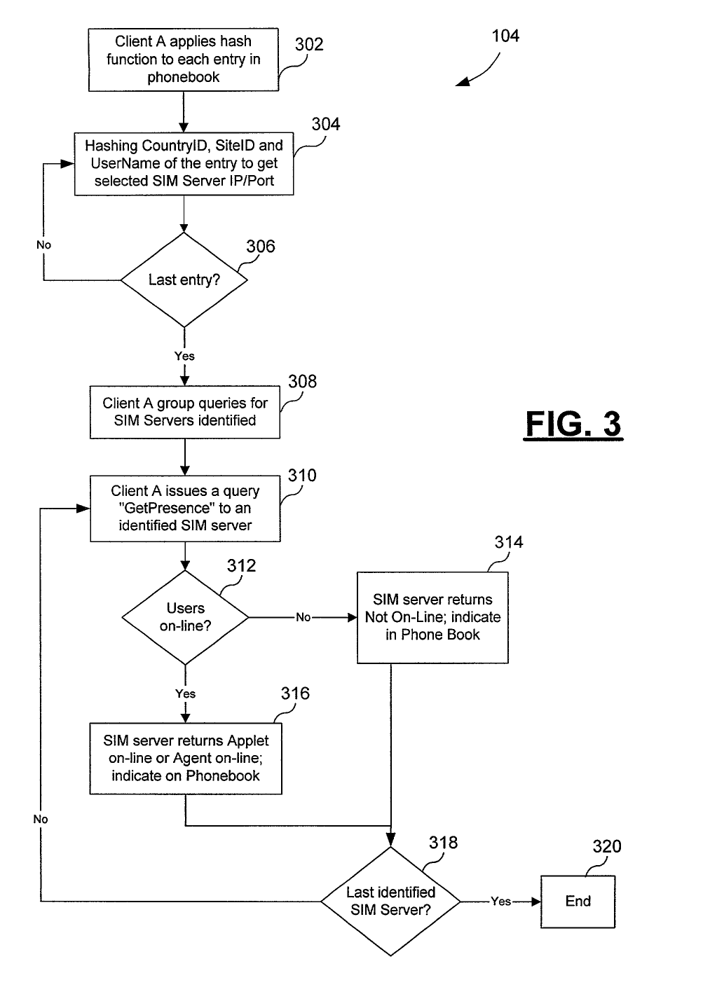

Returning to FIG. 1, after user A logins and registers with selected SIM ServerO, web server 412 provides a phone book to client A. A phonebook helper applet is also launched (step 104). The phonebook helper applet proceeds to determine the on-line presence status of each of the users identified in the entries the phonebook of user A. A process for determining the on-line presence status of a user in process 100 of the present invention is illustrated in FIG. 3.

At step 302, client A applies the hash function described above to each entry in user A's phone book. Specifically, the hashing is applied to the countryID, siteID and UserName of each of the entry. The hash function returns an index value identifying a selected SIM server for each entry. The index value is used to index an array in the configuration file downloaded in client A to obtain the IP address and port number of the selected SIM server (step 304). Client A repeats the hashing process until the last entry is hashed and the selected SIM server identified (step 306). Client A then proceeds to generate server queries to each of the SIM servers identified to retrieve the on-line presence information of the users in the entries of the phone book. In the present embodiment, in order to optimize the server query process, client A groups the server queries for the SIM servers identified (step 308) and issues a single query to each SIM server to obtain the on-line presence status for all of the users associated with that SIM server. Thus, at step 310, client A issues a query “GetPresence” to a selected SIM server. For example, when user A includes user B in user A's phonebook and the hash function applies to user B's identification values returns SIM Server1 414b as the SIM server associated with user B, client A issues a query “GetPresence” to SIM Server1 414b using the IP address and port number of the SIM Server to obtain the on-line presence status of client B. If client B is on-line (step 312), then SIM Server1 414b returns an on-line indication to client A (step 316). The on-line indication is rendered on the browser of client A so that user A can readily comprehend which of the users in the phonebook is currently on-line. In another embodiment, SIM Server1 414b also returns an indication of whether client B has launched its applet or whether client B has registered using the agent only. If client B is not currently registered, then SIM Server1 414b returns a not-on-line indication to client A, indicating that client B is currently not on-line and thus not available for PC to PC audio communications (step 314). Of course, when user B logins to communications system 400, client B (operated by user B) registers with SIM Server1 414b using the same registration procedure described above with respect to client A.

Client A issues queries to each of the identified SIM server until the last SIM server has been queried (step 318). Thus, if other entries on user A's phone book identifies SIM serverM, client A issues a query “GetPresence” to SIM serverM to obtain the on-line presence information of those entries. The on-line presence determination process ends when the last identified SIM server has been queried (step 320). User A can then proceed with process 100 of FIG. 1 to place a PC to PC call with any users which have been indicated as being current on-line.

While the above description concerns with establishing PC to PC audio communications between two users using VoIP technology, the communications system of the present invention can also support other communication schemes such as PC to telephone calling or telephone to telephone calling. Thus, in one embodiment of the present invention, the method for PC to PC audio communications described herein constitutes one operation mode of a VoIP communications system. The VoIP communications system includes facilities to support PC to telephone calling as described in the '898 patent application. The VoIP communications system also includes facilities to support inbound telephone calls from a conventional telephone to any one of a computer terminal, a telephone or a mobile communication device. A system for providing inbound VoIP communications is described in concurrently filed and commonly assigned U.S. patent application Ser. No. xx/xxx,xxx, entitled “Inbound VoIP Communications System”, of Chang Hwan Oh (Attorney docket no. M-9683 US), which is incorporation herein by reference in its entirety.

The following table identifies the code segments included in Appendix A that are executed by each of the SIM servers of communications system 400 for managing PC to PC calls according to one embodiment of the present invention.

| Filename | Description |
|---|---|
| simserver.c and | The main thread for the SIM Server. |
| simserver.h | Spawns all child threads. Receives |
| | and queues TCP connections and UDP |
| | packets. |
| simthread.c | Child threads that process the |
| | queued connections and UDP packets |
| | and call the appropriate functions |
| | to handle the request. |
| simpacket.c and | Collection of functions, each |
| simpacket.h | handling a specific request from |
| | the UDP packets or TCP connections. |
| | Accesses the data structure to |
| | retrieve/set information. |
| simtable.c and | The main data structure that holds |
| simtable.h | the information required to keep |
| | track of sessions, registrations, |
| | and other user data. |
| simconfig.c and | Parses the command line and sets |
| simconfig.h | configuration options. |
| timekeeper.c and | A thread that wakes up every second |
| timekeeper.h | to update the “current time” global |
| | variable. |
| simdef.h | Header file that describes the most |
| | common constants and structures for |
| | SIM Servers. |

Appendix B contains the interface between the SIM servers, the web server script, the client applet and the client agent according to one embodiment of the present invention.

The above detailed descriptions are provided to illustrate specific embodiments of the present invention and are not intended to be limiting. Numerous modifications and variations within the scope of the present invention are possible. The present invention is defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A method for providing audio communications between a first client and a second client, comprising:
accessing a web site;
providing link information to an entry node;
providing login information of said first client to said entry node;
registering said first client with a first server;
querying a second server to obtain an on-line presence status of said second client;
if said on-line presence status indicates that said second client is on-line, querying said second server for link information of said second client; and
establishing a connection between said first client and said second client for audio communication.

2. The method of claim 1, wherein said providing login information of said first client to said entry node comprises:
providing a username and a password of a user associated with said first client.

3. The method of claim 1, wherein said registering said first client with a first server comprises:
applying at said entry node a hash function to a set of user identification values associated with said first client;
obtaining link information of said first server based on said set of user identification values;
obtaining a session identification number for said first client from said first server;
providing said session identification number to said first client;
launching a client-side applet at said first client; and
registering said first client with said first server using said applet.

4. The method of claim 3, wherein said registering with said first server using said applet comprises:
downloading onto said first client a configuration file from said entry node;
applying a hash function to said set of user identification values;
obtaining line information identifying said first server based on said set of user identification values; and
registering link information and said session identification number of said first client at said first server.

5. The method of claim 3, wherein said set of user identification values comprises a countryID, a siteID, and a username associated with a user of said first client.

6. The method of claim 3, wherein said link information of said first server comprises an IP address and a port number of said first server.

7. The method of claim 3, wherein said link information of said first client comprises an IP address and a port number of said first client.

8. The method of claim 1, wherein said link information of said second client comprises an IP address and a port number of said second client.

9. The method of claim 1, further comprising:
registering said second client with said second server before registering said first client.

10. The method of claim 9, wherein said registering said second client with said second server comprises:
applying at said entry node a hash function to a set of user identification values associated with said second client;
obtaining link information of said second server based on said set of user identification values;
obtaining a session identification number for said second client from said second server;
providing said session identification number to said second client;
launching a client-side applet at said second client; and
registering said second client with said second server using said applet.

11. The method of claim 1, wherein said querying a second server to obtain an on-line presence status of said second client comprises:
applying at said first client a hash function to a set of user identification values associated with said second client;
obtaining link information identifying said second server based on said set of user identification values of said second client;
querying said second server using said set of user identification values of said second client to determine whether said second client is on-line; and
providing said first client an on-line presence indication from said second server indicating said second client is on-line.

12. The method of claim 1, wherein after said act of registering said first client with a first server, said method further comprises:
providing a phonebook to said first client, said phonebook including a plurality of entries identifying a plurality of clients;
wherein said querying said first server to obtain said on-line presence status of said second client comprises querying a plurality of servers to obtain an on-line presence status of each of said plurality of clients identified in said phonebook of said first client, said plurality of clients including said second client.

13. The method of claim 12, wherein said querying a plurality of servers comprises:
applying at said first client a hash function to a set of user identification values associated with each of said plurality of clients;
obtaining link information identifying said plurality of servers, each of said plurality of servers being associated with said set of user identification values of each entry of said phonebook;
querying each of said plurality of servers using said set of user identification values of said plurality of clients to determine which of said plurality of clients is on-line; and
providing to said first client an on-line presence indication from said plurality of servers indicating which of said plurality of clients is on-line.
